(19) United States
(12) Patent Application Publication
(10) Pub. No.: US 2009/0260979 A1
(43) Pub. Date: Oct. 22, 2009

(54) WASHING APPARATUS, APPARATUS FOR MANUFACTURING PLATING-FILMED WEB, WASHING PROCESS, AND PROCESS FOR MANUFACTURING PLATING-FILMED WEB

(75) Inventor: Hirokazu Saitou, Kanagawa (JP)

Correspondence Address: YOUNG & THOMPSON, 209 Madison Street, Suite 500, ALEXANDRIA, VA, 22314, US

(73) Assignee: FUJIFILM CORPORATION, MINATO-KU (JP)

(21) Appl. No.: 11/997,407

(22) PCT Filed: Mar. 20, 2007
(86) PCT No.: PCT/JP2007/056515

§ 371 Date: Jan. 31, 2008

(30) Foreign Application Priority Data
Mar. 31, 2006 (JP) 2006-100694

(51) Int. Cl. C25D 17/02; G03D 3/13; B08B 1/02

(52) U.S. Cl. 204/212; 134/122 R; 134/15

(57) ABSTRACT

The present invention provides a washing apparatus which washes a web while conveying the web. The washing apparatus includes a squirting component which ejects fresh washing liquid at the web and a first washing tank which is disposed at an upstream side of a conveyance direction of the web relative to the squirting component. The first washing tank washes the web that is passing through the first washing tank, and takes in the washing liquid that has been ejected at the web by the squirting component.

### TECHNICAL FIELD

The present invention relates to a washing apparatus which washes a long, wide belt-form web while conveying the web, an apparatus for manufacturing a plating-filmed web which is equipped with this washing apparatus, a process for washing the web, and a process for manufacturing a plating-filmed web in which this washing process is employed.

### BACKGROUND ART

In a system for forming a plating coating while continuously conveying a web, the web is dipped in a plating tank and it is necessary to wash the plating-filmed web to remove a plating liquid.

As such a washing process, processes are known such as those described in, for example, Japanese Patent Application Laid-Open (JP-A) No. 5-89453 (FIG. 1, FIG. 5, etc. thereof), JP-A No. 9-13199 and the like, in which a plating-filmed web is passed through a washing tank featuring baffle plates. A process is also known, as described in JP-A No. 2004-270003, of providing sealing rollers, brushes or the like between multiple washing tanks, and conveying the plating-filmed web through the multiple washing tanks for washing.

However, in the processes described in JP-A Nos. 5-89453 and 9-13199, when washing processing is being applied to the plating-filmed web with a washing liquid, the washing liquid is polluted with processing liquids of stages prior to the washing stage, and satisfactory washing results are not obtained.

Furthermore, with the sealing rollers, brushes or the like described in JP-A No. 2004-270003, sealing between washing tanks is difficult and washing liquid leakages occur, which is a cause for concern. Moreover, with an immersion-type washing tank, simply passing a plating-filmed web through a washing liquid in a static state cannot provide satisfactory washing results, in addition to which the washing liquid is not being utilized efficiently.

### DISCLOSURE OF THE INVENTION

The present invention has been devised in consideration of the present circumstances, and an objective of the present invention is to provide a washing apparatus, plating-filmed web production facility, washing process and plating-filmed web manufacturing process which can efficiently and reliably wash a web which is being continuously conveyed with small quantities of washing liquid.

In order to address the problem described above, a first aspect of the present invention is a washing apparatus which washes a web while conveying the web, the washing apparatus including: a squirting component which ejects fresh washing liquid at the web; and a first washing tank which is disposed at an upstream side of a conveyance direction of the web relative to the squirting component, washes the web that is passing through the first washing tank, and takes in the washing liquid that has been ejected at the web by the squirting component.

According to the first aspect, the first washing tank is provided at the web conveyance direction upstream side relative to the squirting component, and the web passing therethrough is washed by the first washing tank. The web that has passed through the first washing tank is conveyed to the squirting component, and fresh washing liquid is ejected at the web. Thus, the web is washed. Then, after the web has been washed by the squirting component, the washing liquid is taken into the first washing tank. Therefore, after the web is washed by the first washing tank, into which washing liquid that has washed the web one time has passed, fresh washing liquid is ejected by the squirting component to wash the web, and thus the web is maintained in a clean state. Therefore, it is possible to wash the web efficiently and reliably with small amounts of washing liquid.

The washing apparatus of the first aspect may further include a pair of liquid-extracting rollers which nip the web at the web conveyance direction downstream side relative to the squirting component, with a portion of the squirting component ejecting the washing liquid at the liquid-extracting rollers.

According to this aspect, the pair of liquid-extracting rollers is provided at the web conveyance direction downstream side relative to the squirting component, the web that has been washed by the squirting component is nipped by the pair of liquid-extracting rollers, and the web which has been wetted with the washing liquid is squeezed. Here, because a portion of the squirting component ejects the washing liquid at the liquid-extracting rollers, pollutants at the liquid-extracting rollers are removed, and adherences of pollutants to the web are suppressed.

In the washing apparatus of the first aspect, the washing liquid may be ejected at the liquid-extracting rollers from below.

According to this aspect, because the washing liquid is ejected from below at the liquid-extracting rollers, the washing liquid will not accumulate at a nipping portion at the upper side of the liquid-extracting rollers, and a liquid-extracting effect is maintained.

The washing apparatus of the first aspect may further include: a second washing tank at the web conveyance direction upstream side relative to the first washing tank, the second washing tank neighboring the first washing tank and sandwiching a partition wall with the first washing tank; and a dividing plate disposed at the second washing tank side relative to the partition wall, an upper end portion of the dividing plate being higher than the partition wall, and the dividing plate structuring a fluid outlet between the dividing plate and a floor face of the second washing tank, with the washing liquid in the first washing tank being allowed to overflow at the partition wall and being guided through the fluid outlet into the second washing tank.

According to this aspect, the second washing tank, which sandwiches the partition wall and neighbors the first washing tank, is disposed at the web conveyance direction upstream side relative to the first washing tank. The web that passes through the second washing tank then passes through the first washing tank. At the second washing tank side relative to the partition wall, the dividing plate is provided, whose upper end portion is higher than the partition wall and which structures the fluid outlet between the dividing plate and the floor face of the second washing tank. The washing liquid of the first washing tank overflows the partition wall, passes through between the partition wall and the dividing plate, and is guided through the fluid outlet at the lower side into the second washing tank. That is, because the dividing plate is present, the washing liquid circulates in the second washing tank and the washing liquid will not move only at the upper surface thereof. Furthermore, as the web is conveyed from the second washing tank into the first washing tank, the web is washed with cleaner washing liquid. Therefore, it is possible to effectively wash the web with less washing liquid.

A second aspect of the present invention is an apparatus for manufacturing a plating-filmed web, the production facility, while conveying a web which includes a conductive surface, causing the conductive surface of the web to contact a cathode roller and forming a plating coat at the conductive surface of the web in an electroplating solution, and the production facility being provided with the washing apparatus of the first aspect at a downstream side of a conveyance direction of the web relative to the electroplating solution, the washing apparatus washing off plating liquid that has adhered to the web.

According to the second aspect, the washing apparatus of the first aspect is provided at the web conveyance direction downstream side relative to the electroplating solution. In the electroplating solution, a plating coating is formed at the conductive surface of the web, and then plating liquid adhering to the web is washed off by the washing apparatus. Consequently, it is possible to efficiently and reliably wash the web with small amounts of the washing liquid.

A third aspect of the present invention is a washing process for washing a web while conveying the web, the process including: an ejection step of ejecting fresh washing liquid at the web; and, prior to the ejection step, a step of passing the web through a first washing tank, which takes in the washing liquid that has been ejected at the web.

According to the third aspect, the first washing tank is provided, which takes in the washing liquid which has been ejected at the web by the ejection step. The web is passed through the first washing tank and the web is washed with used washing liquid, and thereafter the web is ejected with the fresh washing liquid in the ejection step for washing the web. Therefore, the web advances to a cleaner state, and it is possible to efficiently and reliably wash the web with small amounts of washing liquid.

In the washing process of the third aspect, the washing liquid in the first washing tank may overflow and be guided into a second washing tank, and, prior to the web being passed through the first washing tank, the web may be passed through the second washing tank.

According to this aspect, the second washing tank is provided, into which the washing liquid of the first washing tank overflows and is guided. The web is passed through the second washing tank and the first washing tank in that order, and thus the web is washed by progressively cleaner washing liquid. Consequently, it is possible to efficiently wash the web with less washing liquid.

A fourth aspect of the present invention is a process for manufacturing a plating-filmed web, the manufacturing process including, while conveying a web which includes a conductive surface, causing the conductive surface of the web to contact a cathode roller and forming a plating coat at the conductive surface of the web in an electroplating solution, and, after conveying the web through the electroplating solution, washing off plating liquid that has adhered to the web with the washing process of the third aspect.

According to the fourth aspect, in the electroplating solution, a plating coating is formed at the conductive surface of the web, and then plating liquid adhering to the web is washed off with the washing process of the third aspect. Consequently, it is possible to efficiently and reliably wash the web with small amounts of washing liquid.

The present invention is constituted as described above, and thus can efficiently and reliably wash a web with small amounts of washing liquid while conveying the web.

### BRIEF DESCRIPTION OF THE DRAWINGS

FIG. 1 is a schematic vertical sectional view showing a plating-filmed web production facility, which is provided with a washing apparatus of an embodiment of the present invention.

FIG. 2 is a schematic sectional view showing the washing apparatus, which is disposed at an electroplating apparatus shown in FIG. 1.

### BEST MODE FOR CARRYING OUT THE INVENTION

An embodiment of the present invention will be described on the basis of the drawings. Herein, members having substantially the same functions are assigned the same reference numerals throughout the drawings, and duplicative descriptions may be omitted.

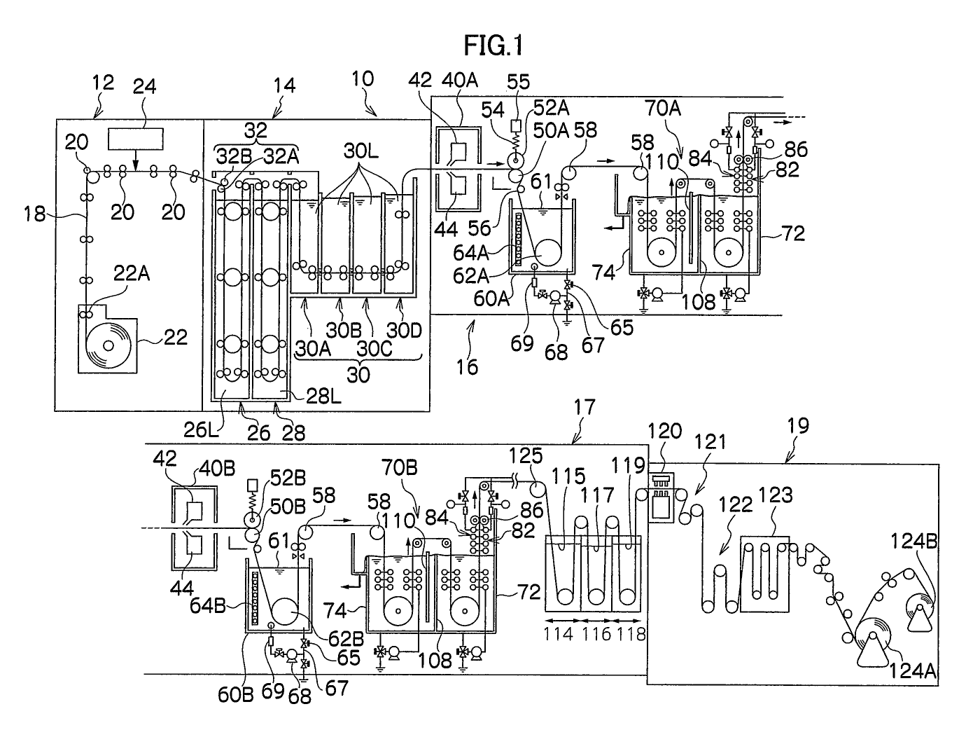

FIG. 1 is a schematic structural diagram showing a plating-filmed web production facility 10 which is provided with a washing apparatus 70A relating to the embodiment of the present invention.

As shown in FIG. 1, this plating-filmed web production facility 10 is structured with an exposure apparatus 12, a developing apparatus 14, an electroplating apparatus 16 provided with the washing apparatus 70A, a post-processing apparatus 17, and a winding apparatus 19.

First, the exposure apparatus 12 will be described. The exposure apparatus 12 is an apparatus for performing exposure of a required microline pattern (for example, a lattice pattern, a honeycomb pattern or the like) while conveying a light-transmissive photosensitive web 18. The photosensitive web 18 is formed of a long, wide belt-form web (for example, a long, wide-belt-form film) at which a layer containing silver salt is provided and which serves as a material to be plated. By this pattern exposure, a patterned microline-form metallic silver portion is formed at exposed portions of the silver salt-containing layer of the photosensitive web 18.

A plurality of conveyance roller pairs 20 are provided in the exposure apparatus 12, along a conveyance path of the light-transmissive photosensitive web 18. The conveyance roller pairs 20 are structured with driving rollers and nipping rollers.

A supply section is provided in the exposure apparatus 12, at a portion that is furthest upstream in the conveyance direction. A magazine 22 is installed at the supply section. The magazine 22 accommodates the long, wide, belt-form light-transmissive photosensitive web 18, which has been wound up into a roll. Drawing out rollers 22A are provided at the light-transmissive photosensitive web 18, which draw out the light-transmissive photosensitive web 18 and convey the light-transmissive photosensitive web 18 to the downstream side.

An exposure unit 24 is provided at the conveyance direction downstream side from the supply section. The exposure unit 24 implements exposure onto the light-transmissive photosensitive web 18. The exposure unit 24 may be a continuous surface exposure unit which employs a photomask, and may be a scanning exposure unit with a laser beam. Such a scanning exposure unit can preferably employ a scanning exposure system which utilizes a gas laser, light-emitting diodes, a semiconductor laser or a monochromatic high-density light, such as a second harmonic generation light source (SHG) in which a semiconductor laser or a solid state laser employing a semiconductor laser for an excitation light source is combined with a nonlinear optical crystal, or the like. Further, the scanning exposure unit can also employ a scanning exposure system which utilizes a KrF excimer laser, an ArF excimer laser, an F2 laser or the like.

Further, in order to make the scanning exposure unit more compact and inexpensive, the light source thereof may employ a semiconductor laser or a second harmonic generation light source (SHG) in which a semiconductor laser or a solid state laser is combined with a nonlinear optical crystal. In particular, a semiconductor laser may be employed in order to design a device which is compact, inexpensive, long-lasting and highly stable.

As a laser light source of the scanning exposure unit, it is possible to preferably employ, for example, a blue semiconductor laser with wavelength 430 to 460 nm (presented by Nichia Corporation at the 48th meeting of the Japan Society of Applied Physics and Related Societies, March, 2001), a green laser with wavelength around 530 nm in which a semiconductor laser (emission wavelength around 1060 nm) is wavelength-converted by an SHG crystal of LiNbO₃ with a waveguide-form inversion domain structure and emitted, a red semiconductor laser with wavelength around 685 nm (HITACHI Type No. HL6738MG), a red semiconductor laser with wavelength around 650 nm (HITACHI Type No. HL6501MG), or the like.

The exposure apparatus 12 is not limited to the structures described above. It is also possible to employ usual exposure devices which are used for silver salt photographic films, printing papers, platemaking films, photomask emulsion masks, and the like.

Next, the developing apparatus 14 will be described. The developing apparatus 14 is disposed at the conveyance direction downstream side of the exposure apparatus 12, and is an apparatus which performs development, fixing and washing of the light-transmissive photosensitive web 18 which has been subjected to the exposure of the required microline pattern.

The developing apparatus 14 is provided with a developing tank 26, a bleaching and fixing tank 28 and a rinsing tank 30, in that order from the conveyance direction upstream side. The rinsing tank 30 is formed with a first rinsing tank 30A, a second rinsing tank 30B, a third rinsing tank 30C and a fourth rinsing tank 30D. In the developing tank 26, for example, a developing liquid 26L is stored in a predetermined amount, in the bleaching and fixing tank 28, a bleaching and fixing liquid 28L is stored in a predetermined amount, and in the rinsing tanks 30A to 30D, a washing liquid 30L is stored in predetermined amounts. The photosensitive web 18 is conveyed in the liquids of the respective processing tanks 26 to 30 by rollers and guides in the processing tanks 26 to 30. Thus, the photosensitive web 18 is subjected to the respective processes of developing, fixing and washing. At a furthest upstream side of the developing tank 26, a feed-in roller pair 32 is provided, which is equipped with a driving roller 32A and a roller 32B which rotates in accordance with rotation of the driving roller 32A. This feed-in roller pair 32 guides the photosensitive web 18 which is fed out from the exposure apparatus 12 into the developing liquid 26L.

Here, usual development and processing techniques which are used for silver salt photographic films, platemaking films, photomask emulsion masks and the like can be employed for the respective processes of development, fixing and washing. The developing liquid 26L, the bleaching and fixing liquid 28L and the washing liquid 30L can also be suitably employed on that basis. For example, the developing liquid 26L is not particularly limited, but a PQ developer, an MQ developer, an MAA developer or the like can be employed. For example, a developer such as CN-16, CR-56, CP45X, FD-3 or PAPITOL manufactured by FUJIFILM, C-41, E-6, RA-4, D-19 or D-72 manufactured by KODAK, or the like, such developers contained in kits, or a lith developer such as D-85 or the like can be used. Here, the fixing processing is carried out with the objective of removing and stabilizing an unexposed portion of the silver salts.

It is also possible to include an image quality-improving agent in the developing liquid 26L, with a view to improving image quality. An image quality-improving agent can be, for example, a nitrogen-containing heterocyclic compound such as benzotriazol or the like. Further, in a case of employing a lith developer, it is particularly preferable to use polyethylene glycol.

The photosensitive web 18 that has passed through the respective processing tanks 26 to 30 of the developing apparatus 14 is ejected from the developing apparatus 14 without being dried.

Next, the electroplating apparatus 16 will be described. The electroplating apparatus 16 is an apparatus which applies electroplating processing to the photosensitive web 18, which has been subjected to exposure and development to form the microline-form metallic silver portion, and forms a plating (a conductive metallic portion) at which conductive particles are carried at the metallic silver portion.

In the electroplating apparatus 16, a moisture removal device 40A, which removes moisture from the photosensitive web 18 that has passed through the rinsing tank 30, is disposed at the photosensitive web 18 conveyance direction upstream side. In the moisture removal device 40A, air knife devices 42 and 44 are disposed at each of two sides of the photosensitive web 18. The air knife devices 42 and 44 blow air knives from the two sides of the photosensitive web 18, and thus remove moisture that has adhered to the photosensitive web 18.

At the photosensitive web 18 conveyance direction downstream side relative to the moisture removal device 40A, a cathode roller 50A is disposed, which implements electricity supply while touching against the metallic silver portion of the photosensitive web 18. A resilient roller 52A is disposed at a position opposing the cathode roller 50A with the photosensitive web 18 sandwiched therebetween, and causes the metallic silver portion of the photosensitive web 18 to contact the cathode roller 50A. At the resilient roller 52A, a resilient layer is formed of rubber or the like at an outer peripheral face of a rotatably supported core piece. Urethane rubber or the like is used for the resilient layer.

Spring-loaded members 54 are attached at each of two end portions of the core piece structuring the resilient roller 52A, so as not to interfere with rotation of the core piece. Weights 55 are attached to upper portions of the spring-loaded members 54. A pressure force with which the photosensitive web 18 presses against the cathode roller 50A (a pressure force at a nipping portion) is regulated by these weights 55. Because the photosensitive web 18 is pressed against the cathode roller 50A by the resilient roller 52A, the photosensitive web 18 and the cathode roller 50A can closely contact.

At the photosensitive web 18 conveyance direction downstream side relative to the cathode roller 50A, a support roller 56 is disposed, which guides the photosensitive web 18, and further to the downstream side thereof, a plating tank 60A is disposed, which is filled with a plating liquid 61. At this stage, the metallic silver portion of the photosensitive web 18 which has been touched against the cathode roller 50A is conveyed by a submerged roller 62A in the plating solution of the plating tank 60A. A case 64A, which is filled with copper balls, serves as an anode electrode and the cathode roller 50A serves as a cathode electrode, electricity is supplied by a DC power supply, and thus a layer-form plating coat is formed on the photosensitive web 18. In the present embodiment, electricity is supplied from the cathode roller 50A to the case 64A which is the anode electrode by the DC power supply, and a current density at the photosensitive web 18 is set to 0.2 to 10 A/dm² to form the plating coat.

For this electroplating processing, an electroplating technique which is used for, for example, printed circuit boards or the like can be employed. Electrolytic copper-plating is preferable as the electroplating. In the present embodiment, an electrolytic copper-plating solution is employed as the plating liquid 61. The electrolytic copper-plating solution may be a copper sulfate solution, a copper pyrophosphate solution, a copper fluoroborate solution or the like. Chemical species which can be included in the electrolytic copper-plating solution include: copper sulfate, copper chloride or the like; a sulfate which enables increases in stability and conductivity of the plating solution and more uniform electrodeposition; chlorine, for effects of promoting dissolution of the anode and assisting additives; polyethylene oxide as an additive for improving stability of the solution and plating fineness; bipyridine; and so forth.

Anyway, as shown in FIG. 1, a pipe 67 for circulation communicates with a lower portion of the plating tank 60A. A pump 68, a filter 69 and a plurality of closable valves 65 are provided on the pipe. The plating liquid 61 in the plating tank 60A is caused to flow in the pipe 67 by the pump 68, and is returned through the filter 69 into the plating tank 60A, and thus is circulatingly employed.

As shown in FIG. 1, a plurality (two in the present example) of support rollers 58, which guide the photosensitive web 18, are disposed at the photosensitive web 18 surface conveyance direction downstream side relative to the plating tank 60A, and further to the conveyance direction downstream side thereof, the washing apparatus 70A is disposed. This washing apparatus 70A is equipped with a first washing tank 72 and a second washing tank 74, which are filled with washing water L, in that order from the photosensitive web 18 conveyance direction downstream side to the upstream side. A plurality of pipes 82 (82A and 82B) and 84 (84A and 84B), which eject fresh washing water L, are provided at the photosensitive web 18 conveyance direction downstream side of the first washing tank 72, being above the first washing tank 72.

A submerged roller 76A is provided in the second washing tank 74 and a submerged roller 76B is provided in the first washing tank 72. Above a boundary between the first washing tank 72 and the second washing tank 74, two conveyance rollers 78A and 78B are disposed substantially horizontally. Thus, after the photosensitive web 18 has been conveyed in the washing water L of the second washing tank 74, the photosensitive web 18 is guided and conveyed by the submerged roller 76A and the two conveyance rollers 78A and 78B, and is conveyed into the washing water L of the first washing tank 72. The photosensitive web 18 which has passed through the first washing tank 72 is guided by the submerged roller 76B and a support roller 80, which is disposed thereabove, and conveyed upward.

Above the first washing tank 72, a plurality (four in the present example) of the long, narrow pipes 82A and 82B are disposed substantially in parallel in a lateral direction, opposing the face of one side of the photosensitive web 18. Meanwhile, a plurality (four in the present example) of the long, narrow pipes 84A and 84B are disposed substantially in parallel in the lateral direction, opposing the face of the other side of the photosensitive web 18. Pluralities of nozzles are formed in the pipes 82A and 84A. The nozzles eject the washing water L orthogonally to the photosensitive web 18 surface or at a slight downward angle.

A pair of liquid-extracting rollers 86, which press against front and rear of the photosensitive web 18 surface, are disposed above the uppermost pipes 82B and 84B, being at the photosensitive web 18 surface conveyance direction downstream side thereof. In accordance with conveyance of the photosensitive web 18, the liquid-extracting rollers 86 rotate in the directions of the arrows. Pluralities of nozzles are formed in diagonally upward portions of the pipes 82B and 84B, so as to eject the washing water L in directions towards the liquid-extracting rollers 86 from therebelow. Because the washing water L is ejected at the liquid-extracting rollers 86 from below, the washing water L will not pool at the upper side of the liquid-extracting rollers 86, and an effect of water extraction from the photosensitive web 18 can be maintained.

In the present embodiment, diameters of the nozzles formed in the pipes 82A, 82B, 84A and 84B are set to around 0.3 mm. The diameters of the nozzles are made small in order to increase ejection velocity of the washing water L. Thus, the washing water L is ejected from the pluralities of nozzles as a mist. The liquid-extracting rollers 86 are formed of PVA (polyvinyl alcohol), and are employed in a state in which peripheral surfaces thereof are continuously moistened with the washing water L.

The plurality of pipes 82A and 82B branch from a supply pipe 90, which supplies the fresh washing water L, and the plurality of pipes 84A and 84B branch from a supply pipe 92, which supplies the fresh washing water L, at outer sides relative to the positions opposing the photosensitive web 18. The supply pipes 90 and 92 branch from a single inlet pipe 94. At each of the supply pipes 90 and 92, a flow regulating valve 96, a pressure gauge 98 and a flowmeter 100 are provided. The flow regulating valve 96 controls to keep flow amounts constant. Consequently, the washing water L supplied to the plurality of pipes 82A and 82B and the plurality of pipes 84A and 84B is regulated to predetermined flow amounts. Here, the flow amounts of washing water are set such that, if the plating coat is formed at only one face of the photosensitive web 18, larger amounts of the washing water L are ejected thereat than at a rear face with respect to the plating-coated face.

Further, the first washing tank 72 is provided below the plurality of pipes 82A and 82B and the plurality of pipes 84A and 84B, and is structured such that the washing water L that has been ejected from the plurality of pipes 82A and 82B and the plurality of pipes 84A and 84B passes along the photosensitive web 18 and flows into the first washing tank 72. A plurality of substantially ‘U’-shaped (for example, square-form ‘U’ shape) pipes 102 are provided inside the first washing tank 72, at the upstream side and the downstream side of the submerged roller 76B. The pipes 102 eject washing water at the front and rear of the photosensitive web 18. Pluralities of nozzles are formed in the pipes 102, which eject the washing water L in directions orthogonal to the photosensitive web 18. The pipes 102 are disposed with the photosensitive web 18 slotted into the opening portions of the substantial ‘U’ shapes, and thus are disposed so as to oppose the front and rear of the photosensitive web 18.

A circulation pipe 104 is provided at a floor portion of the first washing tank 72, and makes a junction with the plurality of pipes 102. A flow regulating valve 105 and a circulating pump 106 are provided on the circulation pipe 104. The washing water L in the first washing tank 72 is guided through the circulation pipe 104 line and ejected out the plurality of pipes 102. Thus, the washing water L is circulatingly employed.

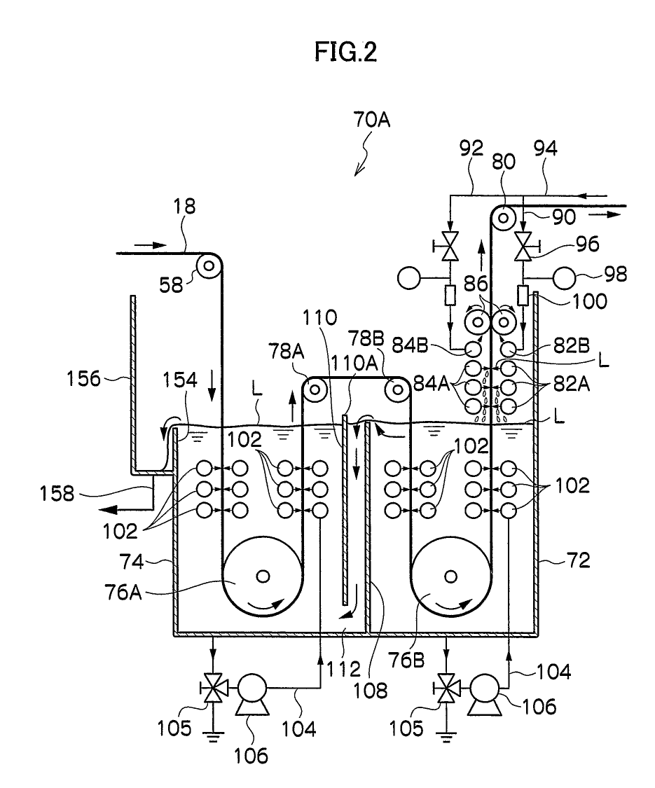

A partition wall 108 is provided between the first washing tank 72 and the second washing tank 74, and a dividing plate 110 is provided substantially in parallel with the partition wall 108 at the second washing tank 74 side relative to the partition wall 108. The dividing plate 110 is formed with an upper end portion 110A being higher than an upper end portion of the partition wall 108, and is provided with a fluid outlet 112 between the dividing plate 110 and a floor face of the second washing tank 74. Thus, as shown by arrows in FIG. 2, the washing water L in the first washing tank 72 overflows over the upper end portion of the partition wall 108, is guided at the dividing plate 110 side, passes between the partition wall 108 and the dividing plate 110, and is guided through the fluid outlet 112 at the lower side into the second washing tank 74. Moreover, because the dividing plate 110 is provided, the washing water L circulates in the second washing tank 74, and a phenomenon of the washing water L only moving at the upper surface thereof in the second washing tank 74 is suppressed.

A plurality of the pipes 102 is also provided in the second washing tank 74, similarly to the first washing tank 72. The circulation pipe 104, flow regulating valve 105 and circulating pump 106 are also provided at the second washing tank 74. Further, a draining tank 156 is provided at the second washing tank 74, at a side thereof which is opposite from the side at which the dividing plate 110 is disposed. The draining tank 156 and the second washing tank 74 sandwich a partition wall 154. The height of an upper end portion of the partition wall 154 is set to the same height as the upper end portion of the partition wall 108. A drainage pipe 158 is provided at a floor portion of the draining tank 156. Thus, the washing water L in the second washing tank 74 overflows over the upper end portion of the partition wall 154, is guided into the draining tank 156, passes through the drainage pipe 158 and is discharged.

In the electroplating apparatus 16 with the structure described above, as shown in FIG. 1, first, the long, wide photosensitive web 18 is conveyed in the direction of the arrows, and moisture that has adhered to the photosensitive web 18 is removed by the air knife devices 42 and 44. Then, at the nipping portion between the cathode roller 50A and the resilient roller 52A, the metallic silver portion of the photosensitive web 18 is made to contact the cathode roller 50A, and is thereafter conveyed to the plating tank 60A. Here, with the case 64A in which copper balls are layered and loaded serving as the anode electrode and the cathode roller 50A serving as the cathode electrode, electricity is supplied by the DC power supply. Thus, a copper-plating film is formed by electroplating of the metallic silver portion of the photosensitive web 18.

Thereafter, the photosensitive web 18 is guided by the support rollers 58 and conveyed to the washing apparatus 70A. In the washing apparatus 70A, the photosensitive web 18 is first conveyed to the second washing tank 74, and within the washing water L of the second washing tank 74, washing water L is ejected at the front and rear or the photosensitive web 18 from the pipes 102, and plating liquid that has adhered to the photosensitive web 18 is washed off. The photosensitive web 18 is guided by the submerged roller 76A and the conveyance rollers 78A and 78B and, after passing through the second washing tank 74, is conveyed to the first washing tank 72. Hence, within the washing water L of the first washing tank 72, washing water L is ejected at the front and rear of the photosensitive web 18 from the pipes 102, and the photosensitive web 18 is washed.

The photosensitive web 18 is further guided by the submerged roller 76B and the support roller 80 and fed out from the first washing tank 72. Thereafter, the photosensitive web 18 passes between the opposing positions of the pipes 82A and 82B and the pipes 84A and 84B, and fresh washing water L is ejected out the pipes 82A and 82B and the pipes 84A and 84B, thus washing the photosensitive web 18.

In the washing apparatus 70A with this form, the washing water L that is ejected out the pipes 82A and 82B and the pipes 84A and 84B flows along the photosensitive web 18 and flows into the first washing tank 72. Furthermore, the washing water L in the first washing tank 72 overflows from the partition wall 108 and is guided through the fluid outlet 112 at the lower side of the dividing plate 110 into the second washing tank 74. Therefore, as the photosensitive web 18 is conveyed to the second washing tank 74, the first washing tank 72 and the portion of opposition of the pipes 82A and 82B and the pipes 84A and 84B, the photosensitive web 18 is washed in a sequence from old washing water L to new washing water L (i.e., progressively cleaner washing water L). Consequently, the photosensitive web 18 can be efficiently and reliably washed with small amounts of the washing water L.

Subsequently, the photosensitive web 18 passes through a portion of pressing by the liquid-extracting rollers 86, and washing water that has adhered to the photosensitive web 18 is squeezed off. At the liquid-extracting rollers 86, because washing water L is being ejected from the pipes 82B and 84B therebelow, the liquid-extracting rollers 86 are washed and maintained in a clean state. Consequently, adherence of pollutants to the photosensitive web 18 is prevented.

In the electroplating apparatus 16, a unit equipped with the moisture removal device 40A, the cathode roller 50A, the plating tank 60A and the washing apparatus 70A is plurally provided (eight units in the present embodiment), and the steps described above are repeated a number of times. Thus, copper plating with a predetermined thickness is formed at the photosensitive web 18.

Further, at the photosensitive web 18 conveyance direction downstream side therefrom, a unit for implementing nickel plating is plurally provided (eight units in the present embodiment), which is equipped with a moisture removal device 40B, a cathode roller 50B, a plating tank 60B and a washing apparatus 70B. This unit repeatedly performs steps the same as those described above a number of times. Thus, a nickel-plating coating with a predetermined thickness is formed at the photosensitive web 18.

Thereafter, as shown in FIG. 1, the photosensitive web 18 passes a roller 125 which can sense tension of the web, through a washing section 114 containing washing water 115 for removing plating liquid and an antirust treatment section 116 containing an antirust treatment liquid 117 for protecting the plating coating, through a washing section 118 containing washing water 119 for removing excess antirust processing liquid, through a drying stage section 120 with a drying fan for removing moisture, through a speed regulation section 121 and through a balance roller section 122, and tension is adjusted. Then, the photosensitive web 18 passes through an accumulator 123 and is formed into web rolls 124 (124A and 124B). In this way, a coating-filmed web is provided.

A practical web conveyance tension is preferably at least 5 N/m and at most 200 N/m. If the tension is less than 5 N/m, the web will start to meander, and control of the conveyance path will be difficult. If the tension exceeds 200 N/m, the plating coating metals formed at the web will have internal strains, and consequently curl will occur in the finished product.

For conveyance tension control, the conveyance tension may be detected using the tension-sensing roller 125, and feedback control may be performed to increase/reduce speed with the speed regulation section 121 so as to keep the tension value constant.

In this way, a plating (a conductive metallic portion) is formed at the microline metallic silver portion of the photosensitive web 18. By such steps, a plating-filmed web can be obtained.

Herein, the number of plating tanks of the electroplating apparatus 16 may be increased beyond eight sets in accordance with a required plating thickness (thickness of the conductive metallic portion). In accordance with the number of tanks, the required plating thickness (conductive metallic portion thickness) can be obtained with ease.

Next, the photosensitive web 18 will be described. The photosensitive web 18 which serves as a material to be plated is, for example, a long, broad, flexible base material formed of a photosensitive material, which is provided with, on a light-transmissive support, a silver salt-containing layer which includes silver salt (for example, silver halide). A protective layer may be further provided on the silver salt-containing layer. This protective layer means, for example, a layer formed of a binder which is gelatin, a high molecular weight polymer or the like. The protective layer is formed on the silver salt-containing layer in order to realize effects of excellent scratch prevention, mechanical characteristics and the like. A thickness of the protective layer is preferably 0.02 to 20 μm, more preferably 0.1 to 10 μm, and even more preferably 0.3 to 3 μm.

In regard to compositions and the like of the silver salt-containing layer, protective layer and the like, silver halide emulsion layers (silver salt-containing layers), protective layers and the like which are used for silver salt photographic films, printing papers, platemaking films, photomask emulsion masks and the like can be suitably employed.

In particular, a silver salt photographic film (i.e., a silver salt photosensitive material) is preferable as the photosensitive web 18 (i.e., the photosensitive material), and a monochrome silver salt photographic film (a monochrome silver salt photosensitive material) is optimal. Furthermore, as the silver salt(s) employed in the silver salt-containing layer, silver halides in particular are most excellent.

Meanwhile, as the light-transmissive support, a single-layer plastic film, or a multi-layer film in which two or more thereof are combined, may be employed. As a raw material of a plastic film, for example, the following can be employed: polyesters such as polyethylene terephthalate (PET), polyethylene naphthalate and the like; polyolefins such as polyethylene (PE), polypropylene (PP), polystyrene, EVA and the like; vinyl-based resins such as polyvinyl chloride, polyvinylidene chloride and the like; and alternatively, polyether ether ketones (PEEK), polysulfones (PSF), polyether sulfones (PES), polycarbonates (PC), polyamides, polyimides, acrylic resins, triacetyl cellulose (TAC) and so forth.

Among these, in regard to transparency, heat resistance, ease of handling and cost, a plastic film to serve as the support is preferably a polyethylene terephthalate film, cellulose triacetate film or the like which is ordinarily employed for a silver salt photographic film (a silver salt photosensitive material), or alternatively a polyimide film. In particular, a polyethylene terephthalate film is most preferable.

Further, in a case of an electromagnetic wave-shielding member for a display, because transparency is required, it is desirable that transparency of the support be high. In such a case, light transmittance of the light-transmissive support over all visible wavelengths is preferably 70 to 100%, more preferably 85 to 100%, and particularly preferably 90 to 100%.

A width of the photosensitive web 18 may be, for example, 50 cm or more, and a thickness may be 50 to 200 μm.

After exposure and development of the photosensitive web 18, the metallic silver portion is formed at the exposed portion. A mass of metallic silver that is included in this metallic silver portion is preferably a content ratio of at least 50% by mass relative to a mass of silver that was included at the exposed portion before exposure, and is more preferably at least 80% by mass. If the mass of silver included at the exposed portion is 50% by mass or more relative to the mass of silver that was included at the exposed portion before exposure, then it will be possible to provide high conductivity with the subsequent electroplating processing, and therefore this is preferable.

In order to provide conductivity to the metallic silver portion that is formed by the exposure and development processing, the electroplating processing is performed by the above-described electroplating apparatus 16 to cause conductive metallic particles to be carried at the metallic silver portion. That is, in the plating-filmed web production facility 10, the light-transmissive photosensitive web 18 provided with the silver salt-containing layer is utilized as a material to be plated, exposure and development are applied to the silver salt-containing layer thereof, and a required microline-form metallic silver portion is formed as a portion to be plated. Because this microline-form metallic silver portion is formed by exposing and developing the silver salt-containing layer, the microline-form metallic silver portion is patterned with extremely fine microlines. When the electroplating processing is applied to this light-transmissive photosensitive web 18, conductive particles are supported on the microline-form metallic silver portion, and thus the conductive metallic portion is formed. Consequently, an electromagnetic wave-shielding member that is provided features a microline-form metallic portion which is patterned by extremely fine microlines and a light-transmissive portion with a large surface area.

In the plating-filmed web production facility 10 which is formed thus, because the washing apparatus 70A is provided, it is possible to efficiently and reliably wash off plating liquid that has adhered to the light-transmissive photosensitive web 18, which is being continuously conveyed, with small quantities of washing water L. Consequently, a burden of washing processing at the time of plating is greatly reduced, an improvement in production efficiency can be achieved, and a finished product can be provided at lower cost.

Anyway, in the washing apparatus 70A of the present embodiment, the first washing tank 72 and the second washing tank 74 are provided. However, the number of washing tanks is not limited by the structure described above, and could be the first washing tank 72 alone. Alternatively, a plurality of three or more washing tanks could be provided.

Further, in the present embodiment, a plating coat is formed at only one face of the photosensitive web 18, but the washing apparatus 70A is also applicable to a case of forming plating coats at both faces. In such a case, it is desirable to specify that matching amounts of the washing water L are ejected from the pipes 82A and 82B and the pipes 84A and 84B at the two sides of the photosensitive web 18. Further, numbers of the pipes 82A and 82B and the pipes 84A and 84B can be suitably specified. Furthermore, although the pipes 82A and 82B and the pipes 84A and 84B are arranged to sandwich the photosensitive web 18 substantially in parallel in the present embodiment, it is also possible to arrange them in, for example, a staggered pattern.

Further, in the present embodiment, the washing water L is employed as the washing liquid, but this is not limited to water. Another washing liquid could be employed, such as an alkaline washing liquid, an acidic washing liquid or the like.

Further, for the present embodiment, a washing apparatus and a washing process which are employed in the plating-filmed web production facility 10 have been described. However, this is not limiting. For example, application is also possible to a washing apparatus and washing process of a light-transmissive conductive material, with a microline-form pattern which is formed of a fine conductive metallic portion, for another industrial product or the like. Similarly, the present embodiment can also be applied to washing apparatuses and washing processes for washing other industrial products and so forth.

1-12. (canceled)

13. A washing apparatus which washes a web while conveying the web, the washing apparatus comprising:
a squirting component which ejects fresh washing liquid at the web; and
a first washing tank which is disposed at an upstream side of a conveyance direction of the web relative to the squirting component, washes the web that is passing through the first washing tank, and takes in the washing liquid that has been ejected at the web by the squirting component,
a pair of liquid-extracting rollers which nip the web at the web conveyance direction downstream side relative to the squirting component,
wherein a portion of the squirting component ejects teh washing liquid at the liquid-extracting rollers.

14. The washing apparatus of claim 13, wherein the washing liquid is ejected at the liquid-extracting rollers from below.

15. The washing apparatus of claim 13 further comprising:
a second washing tank at the web conveyance direction upstream side relative to the first washing tank, the second washing tank neighboring the first washing tank and sandwiching a partition wall with the first washing tank; and
a dividing plate disposed at the second washing tank side relative to the partition wall, an upper end portion of the dividing plate being higher than the partition wall, and the dividing plate structuring a fluid outlet between the dividing plate and a floor face of the second washing tank,
wherein the washing liquid in the first washing tank is allowed to overflow at the partition wall and is guided through the fluid outlet into the second washing tank.

16. A production facility for manufacturing a plating-filmed web, the production facility, while conveying a web which includes a conductive surface, causing the conductive surface of the web to contact a cathode roller and forming a plating coat at the conductive surface of the web in an electroplating solution, and the production facility comprising:
a washing apparatus at a downstream side of a conveyance direction of the web relative to the electroplating solution, the washing apparatus washing off plating liquid that has adhered to the web,
wherein the washing apparatus includes:
a squirting component which ejects fresh washing liquid at the web; and
a first washing tank which is disposed at the web conveyance direction upstream side relative to the squirting component, washes the web that is passing through the first washing tank, and takes in the washing liquid that has been ejected at the web by the squirting component,
a pair of liquid-extracting rollers which nip the web at the web conveyance direction downstream side relative to the squirting component,
wherein a portion of the squirting component ejects the washing liquid at the liquid-extracting rollers.

17. The production facility of claim 16, wherein the washing liquid is ejected at the liquid-extracting rollers from below.

18. The production facility of claim 16, wherein
the washing apparatus further includes:
a second washing tank at the web conveyance direction upstream side relative to the first washing tank, the second washing tank neighboring the first washing tank and sandwiching a partition wall with the first washing tank; and
a dividing plate disposed at the second washing tank side relative to the partition wall, an upper end portion of the dividing plate being higher than the partition wall, and the dividing plate structuring a fluid outlet between the dividing plate and a floor face of the second washing tank, and
the washing liquid in the first washing tank is allowed to overflow at the partition wall and is guided through the fluid outlet into the second washing tank.

19. A washing method for washing a web while conveying the web, the method comprising:
(a) ejecting fresh washing liquid at the web by a squirting component;
(b) prior to (a), passing the web through a first washing tank, which takes in the washing liquid that has been ejected at the web;
(c) nipping the web at the web conveyance direction downstream relative to the squirting component by a pair of liquid-extracting rollers; and
(d) ejecting the washing liquid at the liquid-extracting rollers by a portion of the squirting component.

20. The washing method of claim 19, wherein
the washing liquid in the first washing tank overflows and is guided into a second washing tank, and
prior to the web being passed through the first washing tank, the web is passed through the second washing tank.

21. A method for manufacturing a plating-filmed web, the manufacturing process including, while conveying a web which includes a conductive surface, causing the conductive surface of the web to contact a cathode roller and forming a plating coat at the conductive surface of the web in an electroplating solution, and the manufacturing method comprising
after conveying the web through the electroplating solution, washing off plating liquid that has adhered to the web with a washing method,
wherein the washing method includes:
(a) ejecting fresh washing liquid at the web by a squirting component;
(b) prior to (a), passing the web through a first washing tank, which takes in the washing liquid that has been ejected at the web;
(c) nipping the web at the web conveyance direction downstream side relative to the squirting component by a pair of liquid-extracting rollers; and
(d) ejecting the washing liquid at the liquid-extracting rollers by a portion of the squirting component.

22. The method of claim 21 wherein, in the washing method,
the washing liquid in the first washing tank overflows and is guided into a second washing tank, and
prior to the web being passed through the first washing tank, the web is passed through the second washing tank.

23. The washing method of claim 19, wherein peripheral surfaces of the liquid-extracting rollers remain moistened with the washing liquid by ejecting the washing liquid at the liquid-extracting rollers by a portion of the squirting component.

24. The method of claim 21, wherein peripheral surfaces of the liquid-extracting rollers remain moistened with the washing liquid by ejecting the washing liquid at the liquid-extracting rollers by a portion of the squirting component.

25. The washing method of claim 19, wherein the washing liquid is ejected at the liquid-extracting rollers from below.

26. The method of claim 21, wherein the washing liquid is ejected at the liquid-extracting rollers from below.

27. The washing apparatus of claim 13, wherein the liquid-extracting rollers are formed of polyvinyl alcohol.

28. The production facility of claim 16, wherein the liquid-extracting rollers are formed of polyvinyl alcohol.

29. The washing apparatus of claim 13, wherein the liquid-extracting rollers rotate with conveyance of the web.

30. The production facility of claim 16, wherein the liquid-extracting rollers rotate with conveyance of the web.

31. The washing apparatus of claim 13, wherein the squirting component includes a plurality of nozzles having diameters of a size such that ejection velocity of the washing liquid increases.

32. The production facility of claim 16, wherein the squirting component includes a plurality of nozzles having diameters of a size such that ejection velocity of the washing liquid increases.

33. The washing apparatus of claim 31, wherein the diameters of the nozzles are 0.3 mm.

34. The production facility of claim 32, wherein the diameters of the nozzles are 0.3 mm.
